(19) United States
(12) Patent Application Publication
(10) Pub. No.: US 2006/0139580 A1
(43) Pub. Date: Jun. 29, 2006

(54) Illumination system using multiple light sources with integrating tunnel and projection systems using same

(76) Inventor: Arlie R. Conner, Portland, OR (US)

Correspondence Address: 3M INNOVATIVE PROPERTIES COMPANY, PO BOX 33427, ST. PAUL, MN, 55133-3427, US

(21) Appl. No.: 11/025,285

(22) Filed: Dec. 29, 2004

(51) Int. Cl. G03B 21/28

(52) U.S. Cl. 353/98

(57) ABSTRACT

An illumination system, such as may be used to illuminate an image display device in an image projection system, includes a plurality of light sources capable of emitting output light. In some embodiments, the light sources are light emitting diodes (LEDs). The light-collecting system transforms light from the plurality of light sources into a substantially telecentric illumination beam. The substantially telecentric illumination beam passes into the integrating tunnel, to produce an illumination beam having a substantially uniform brightness cross-sectional profile.

### FIELD OF THE INVENTION

The present disclosure relates to illumination systems that may be used in projection systems. More specifically, the disclosure relates to illumination systems in which light from an array of light sources is collected and integrated in a tunnel integrator.

### BACKGROUND

Illumination systems have a variety of applications, including projection displays, backlights for liquid crystal displays (LCDs) and others. Projection systems usually include a source of light, illumination optics, an image-forming device, projection optics and a projection screen. The illumination optics collect the light generated by the light source and direct the collected light to one or more image-forming devices. The image-forming device(s), controlled by an electronically conditioned and processed digital video signal, produces an image light beam corresponding to the video signal. Projection optics magnify the image light beam and project it to the projection screen.

White light sources, such as arc lamps, have been, and still are, the predominant light sources used for projection display systems. Rotating color wheels are commonly used to select light instantaneously from a particular color band when only one image-forming device is present. More recently, however, light emitting diodes (LEDs) have been considered as an alternative to white light sources. Some advantages of LED light sources include longer lifetime, higher efficiency and superior thermal characteristics.

Traditional optics used in illumination systems have included various configurations, but their off-axis performance has been satisfactory only within narrowly tailored ranges. In addition, optics in traditional illumination systems have exhibited insufficient collection characteristics. In particular, if a significant portion of a light source's output emerges at angles that are far from the optical axis, which is the case for most LEDs, conventional illumination systems are poor at capturing a substantial portion of the emitted light.

### SUMMARY OF THE INVENTION

One particular embodiment of the present disclosure is directed to an optical system that comprises a plurality of light sources capable of emitting output light and an integrating tunnel having an input end. A light-collecting optical system is disposed between the plurality of light sources and the input end of the integrating tunnel. The light-collecting optical system transforms at least a portion of the output light from the plurality of light sources into a substantially telecentric illumination beam. The substantially telecentric illumination beam is coupled to the integrating tunnel.

Another embodiment of the present disclosure is directed to an illumination unit for a projection system. The unit has a plurality of light sources capable of producing light and has light telecentrizing means for making the light from the light sources substantially telecentric. The unit also has light tunnel integrating means for making the substantially telecentric light into an illumination beam of uniform brightness.

Another embodiment of the present disclosure is directed to a projection system that includes an illumination system comprising a first illumination sub-system that has a plurality of light sources capable of emitting output light, an integrating tunnel having an input end, and a light-collecting optical system disposed between the plurality of light sources and the integrating tunnel. The light-collecting optical system transforms the output light from the plurality of LEDs into a substantially telecentric illumination beam. The substantially telecentric illumination beam is integrated in an integrating tunnel to produce an integrated illumination beam. The projection system also includes at least a first image-forming device illuminated by the integrated illumination beam.

Another embodiment of the disclosure is directed to an optical system having a first light source, a first reflective tunnel having an output end and a second reflective tunnel having an input end optically coupled to the output end of the first reflective tunnel. A cross-sectional dimension of the output end of the first reflective tunnel is smaller than a cross-sectional dimension of the input end of the second integrating tunnel. Light from the first light sources passes through the first reflective tunnel to the second reflective tunnel.

The above summary of the present disclosure is not intended to describe each illustrated embodiment or every implementation of the present disclosure invention. The figures and the following detailed description more particularly exemplify these embodiments.

### BRIEF DESCRIPTION OF THE DRAWINGS

The disclosure may be more completely understood in consideration of the following detailed description of various exemplary embodiments in connection with the accompanying drawings, in which:

FIG. 1 schematically illustrates an exemplary embodiment of a projection system, based on an image-forming device that uses an array of deflectable mirrors, that uses an illumination system according to the present disclosure;

FIGS. 2A and 2B schematically illustrate exemplary embodiments of projection systems, based on image-forming devices that use liquid crystal displays, that use an illumination system according to the present disclosure;

FIG. 3A schematically illustrates an exemplary embodiment of an illumination system according to the present disclosure;

FIG. 3B schematically illustrates an exemplary embodiment of a multi-color illumination system according to the present disclosure;

FIGS. 4A and 4B schematically illustrate an exemplary embodiment of an illumination system based on a plurality of light sources according to the present disclosure;

FIGS. 5A and 5B schematically illustrate another exemplary embodiment of an illumination system based on a plurality of light sources according to the present disclosure;

FIG. 5C schematically illustrates a front view of an exemplary embodiment of a lens sheet as may be used in an illumination system as shown in FIG. 5A;

FIGS. 6A and 6B schematically illustrate different exemplary embodiments of illumination systems based on refractive coupling between a plurality of light sources and a tunnel integrator, according to the present disclosure;

FIGS. 7A and 7B schematically illustrate different exemplary embodiments of illumination systems based on reflective coupling between a plurality of light sources and a tunnel integrator, according to the present disclosure;

FIGS. 8A and 8C schematically illustrate additional exemplary embodiments of illumination systems based on reflective coupling between a plurality of light sources and a tunnel integrator, according to the present disclosure;

FIG. 8B schematically illustrates a front view of an exemplary embodiment of an array of reflectors as used in the embodiment shown in FIG. 8A;

FIG. 9A schematically illustrates an exemplary embodiment of a sub-array of light sources provided with a coupler that provides refractive and reflective coupling, according to the present disclosure;

FIG. 9B schematically illustrates the coupler of FIG. 9A in greater detail;

FIG. 9C schematically illustrates an exemplary embodiment of an illumination system based on the sub-array of FIG. 9A;

FIG. 10A schematically illustrates an exemplary embodiment of an array of light sources based on an arrangement of sub-arrays, according go the present disclosure;

FIG. 10B schematically illustrates an exemplary embodiment of an illumination system, based on the array of FIG. 10A, that provides reflective and refractive coupling between the light sources and a tunnel integrator, according to the present disclosure;

FIG. 11A schematically illustrates another exemplary embodiment of an array of light sources based on an arrangement of sub-arrays, according to the present disclosure;

FIG. 11B schematically illustrates an exemplary embodiment of a sub-array of FIG. 11A in greater detail;

FIG. 11C schematically illustrates an exemplary embodiment of an illumination system based on the array of FIG. 11A;

FIG. 11D schematically illustrates another exemplary embodiment of an illumination system according to the present disclosure;

FIG. 12 schematically illustrates another exemplary embodiment of a light source sub-array according to the present disclosure;

FIGS. 13A-D schematically illustrate exemplary embodiments of light sources coupled to light collecting optics according to the present disclosure; and

FIGS. 14A and 14B schematically illustrate light beams to aid understanding of the term telecentric.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

LEDs with higher output power are becoming more readily available, which opens up new applications for LED illumination. Some applications that may be addressed with high power LEDs include their use as light sources in projection and display systems, as illumination sources in machine vision systems and camera/video applications, and even in distance illumination systems such as car headlights.

LEDs typically emit light over a wide angle, and one of the challenges for the optical designer is to efficiently collect the light produced by an LED and direct the light to a selected target area. Another challenge is to package the LEDs effectively, which means collecting light from an assembly having multiple LEDs and directing the collected light to a given target area within a given acceptance cone.

LED-based light sources may be used in many different applications. One application for which illumination systems of the present disclosure are particularly suitable is the illumination of image-forming devices in projection systems. Such projection systems may be used, for example, in rear projection televisions.

In a projection system, illumination light from one or more light sources is incident on one or more image-forming devices. Image light is reflected from, or transmitted through, the image-forming device, and the image light is usually projected to a screen via a projection lens system. Liquid crystal display (LCD) panels, both transmissive and reflective, are used as image-forming devices. One particularly common type of LCD panel is the liquid crystal on silicon (LCoS) panel. Another type of image-forming device, supplied by Texas Instruments, Plano, Tex., under the brand name DLP™, uses an array of individually addressable mirrors, which either deflect the illumination light towards the projection lens or away from the projection lens. While the following description addresses both LCD and DLP™ type image-forming devices, there is no intention to restrict the scope of the present disclosure to only these two types of image-forming devices and illumination systems of the type described herein may use other types of devices for forming an image that is projected by a projection system.

An illumination system as described herein may be used with single panel projection systems or with multiple panel projection systems. In a single panel projection system, the illumination light is incident on only a single image-forming panel. The incident light is modulated, so that light of only one color is incident on the image-forming device at any one time. As time progresses, the color of the light incident on the image-forming device changes, for example, from red to green to blue and back to red, at which point the cycle repeats. This is often referred to as a “field sequential color” mode of operation.

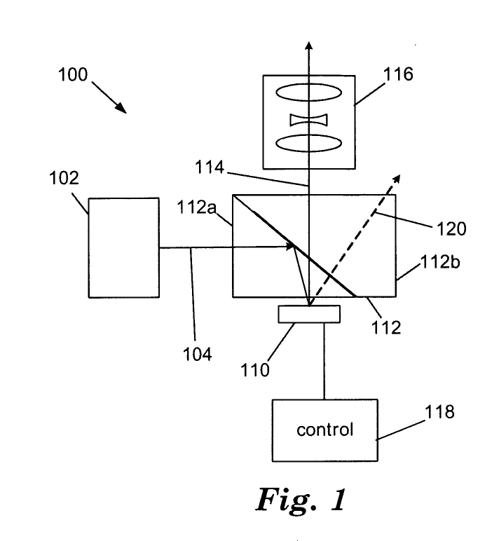

An exemplary embodiment of a single panel projection system 100 that may use an exemplary illumination system described herein is schematically illustrated in FIG. 1. The projection system 100 operates in the “field sequential color” mode. An illumination system 102 generates a beam 104 of light. The illumination system 102 may include a plurality of light sources, such as LEDs, and may also include other elements for collecting the light from the light generating elements and for conditioning the light before incidence on the image-forming devices. Beam conditioning elements may include, for example, an integrator to uniformize the intensity profile of the beam 104, one or more elements to control the polarization of the light, for example a prepolarizer and/or a polarization converter, and various refractive and/or reflective elements to convert the divergence, shape and/or size of the light beam 104 to desired values. In some embodiments, the illumination system 102 may also be able to switch the color of the light beam 104 incident at the image-forming device. In some exemplary embodiments, the illumination system 102 may include independently switched light generating elements that sequentially generate light of different colors. In other exemplary embodiments, the illumination system 102 uses LEDs for generating white light, for example through wavelength conversion using a phosphor, and the white light beam may be filtered to produce sequential colors.

In the illustrated exemplary embodiment, the image-forming device 110 is a DLP™-type micromirror array. Although not necessary for an illumination system of the type described herein, the light beam 104 may be passed to the image-forming device 110 via a prism assembly 112, having prisms 112a and 112b, that uses total internal reflection off an internal surface off at least one of the prisms 112a, 112b to fold light either entering and/or leaving the image-forming device. In the illustrated embodiment, the illumination light beam 104 is totally internally reflected within the prism 112a to the image-forming device 110. The image light beam 114 is directed through the prism assembly 112 to the projection lens unit 116, which projects the image to a screen (not shown).

The image-forming device 110 is coupled to a control unit 118 that controls the image directed to the projection lens unit 116. In the illustrated embodiment, the control unit 118 controls which mirrors of the image-forming device are oriented so as to direct light to the projection lens unit 116 and which mirrors are oriented so as to discard the light as discarded beam 120.

In other types of single panel projection systems, differently colored bands of light may be scrolled across the single panel, so that the panel is illuminated by the illumination system 102 with more than one color at any one time, although any particular point on the panel is instantaneously illuminated with only a single color. Single panel projection systems may use different types of image-forming devices, for example LCoS image-forming devices.

Multiple panel projection systems use two or more image-forming device panels. For example, in a three-panel system, three differently colored light beams, such as red, green and blue light beams, are incident on three respective image-forming device panels. Each panel imposes an image corresponding to the color of its associated illumination light beam, to produce three differently colored image beams. These image beams are combined into a single, full colored, image beam that is projected to the screen. In some exemplary embodiments, the illumination light beams may be obtained from a single illumination beam, for example, by splitting a single white illumination beam into red, green and blue beams, or may be obtained by generating separate red, green and blue beams using different sources, for example red, green and blue LEDs.

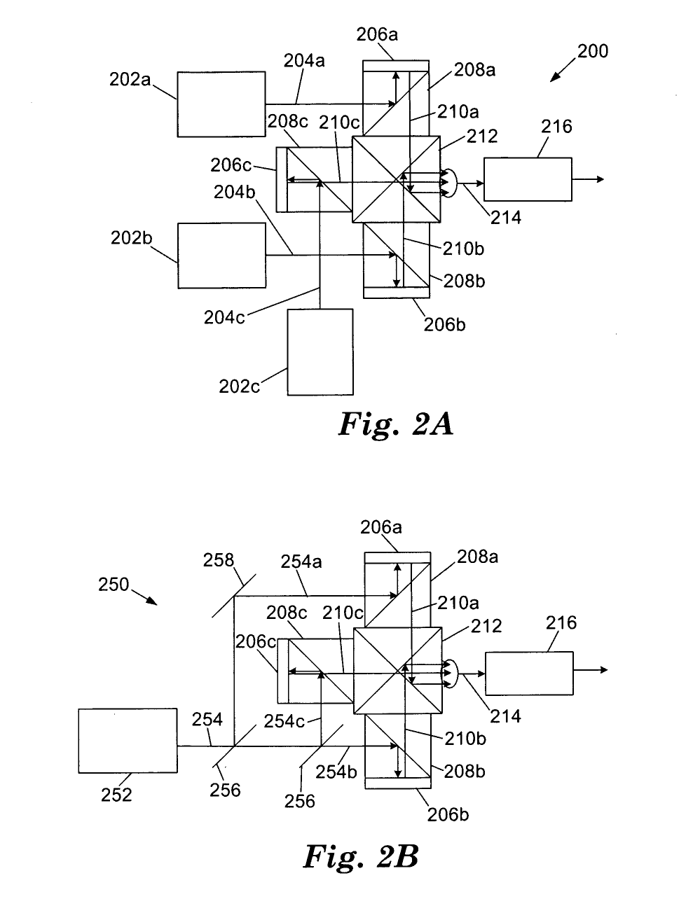

One exemplary embodiment of a multi-panel projection system 200 that may incorporate an exemplary illumination system as described herein is schematically illustrated in FIG. 2A. The projection system 200 is a three-panel projection system, having three different illumination systems 202a, 202b and 202c that direct differently colored light beams 204a, 204b and 204c, for example red, green and blue light beams, to respective image-forming devices 206a, 206b and 206c. In the illustrated embodiment, the panels 206a, 206b and 206c are LCD-based reflective image-forming devices, and so the light 204a, 204b and 204c is coupled to and from the image-forming devices 206a, 206b and 206c via respective polarizing beamsplitters (PBSs) 208a, 208b and 208c. The image-forming devices 206a, 206b and 206c polarization modulate the incident light 204a, 204b and 204c so that the respective image beams 210a, 210b and 210c are separated by the PBSs 208a, 208b and 208c and pass to the combiner unit 212. In the illustrated exemplary embodiment, the illumination light 204a, 204b and 204c is reflected by the PBSs 208a, 208b and 208c to the image-forming devices and the image light beams 210a, 210b and 210c are transmitted through the PBSs 208a, 208b and 208c. In another approach, not illustrated, the illumination light may be transmitted through the PBSs to the image-forming devices, while the image light is reflected by the PBSs.

In the illustrated exemplary embodiment, the color combiner 212 combines image light 210a, 210b and 210c of different colors, for example using one or more dichroic elements. In particular, the illustrated exemplary embodiment shows an x-cube color combiner, but other types of combiner may be used. The three image beams 210a, 210b and 210c are combined in the color combiner 212 to produce a single, colored image beam 214 that is directed by a projection lens system 216 to a screen (not shown).

An exemplary illumination system as described herein may also be used in another exemplary embodiment of a multi-panel projection system 250, schematically illustrated in FIG. 2B. According to this embodiment, a light beam 254, containing light in three different color bands, propagates from an illumination system 252 and is split by color splitting elements 256 for example, dichroic mirrors, into first, second and third beams 254a, 254b and 254c containing light of different colors. The beams 254a, 254b and 254c may be, for example, red, green and blue in color respectively. Beam steering elements 258, for example mirror or prisms, may be used to steer the beams 254, 254a, 254b and 254c.

The performance of optical systems, such as the illumination optics of a projection system, may be characterized by a number of parameters. One of the most important parameters is étendue. The étendue, ε, of an optical system may be calculated using the following formula:
ε=A*Ω≅π*A*sin² θ=π*A*NA²
where Ω is the solid angle of emission or acceptance (in steradians); A is the area of the receiver or emitter, θ is the emission or acceptance angle, and NA is the numerical aperture.

If the étendue of a certain element of an optical system is less than the étendue of an upstream optical element, the mismatch may result in loss of light, which reduces the efficiency of the optical system. Thus, performance of an optical system is usually limited by the element having the smallest value of étendue. Techniques typically employed to decrease or counteract étendue degradation in an optical system include increasing the efficacy of the system (lumens per Watt), decreasing the source size, decreasing the beam solid angle, and avoiding the introduction of additional aperture stops.

One design goal of many projection systems is to produce an illumination light beam that is both bright and uniformly intense. The emission of light from LEDs is somewhat Lambertian in nature, although some commercially available LEDs provide outputs that more closely approximate an ideal Lambertian output than others. One approach to producing a bright and uniform illumination beam from a number of LEDs is to make the light from the LEDs telecentric, or at least substantially telecentric, preserving the étendue of the emitted light as far as possible, and then to integrate the substantially telecentric light in a tunnel integrator. The term “telecentric” means that the angular range of the light is substantially the same for different points across the beam. Thus, if a portion of the beam at one side of the beam contains light in a light cone having a particular angular range, then other portions of the beam, for example at the middle of the beam and at the other side of the beam contain light in substantially the same angular range. Consequently, light at the center of the beam is directed primarily along an axis and has an angular range, while towards the edges of the beam is also directed along the axis and has substantially the same angular range.

The properties of telecentric light beams may be understood better with reference to FIGS. 14A and 14B. FIG. 14A shows the direction of light rays at various points across a non-telecentric light beam propagating along an axis 1402. At the center of the beam, the center ray 1404 is parallel to the axis 1402, and rays 1406, 1408 propagate at angles al relative to the center ray 1404. The rays 1406, 1408 represent the rays whose light intensity is a specified fraction of the intensity of the ray of maximum intensity, in this case the on-axis ray 1404. For example, where the light beam has an f/number of 2.4, the light beam is generally accepted as having a cone half angle, α1, of ±11.7°, where the brightness of the light at ±11.7° is one half the brightness of the axial light.

The dashed line 1412, at the edge of the beam, is parallel to the axis 1402. The ray 1414, representing the direction of the brightest ray at the edge of the beam, propagates at an angle θ relative to the axis 1402. Rays 1416 and 1418 propagate at angles of α2 relative to ray 1414. Ideally, the value of α2 is close to the value of α1, although they need not be exactly the same.

FIG. 14B shows the directions of light rays at various points across a telecentric light beam. At the center of the beam, the axial ray 1454 propagates in a direction parallel to the axis 1452, with rays 1456, 1458 propagating at angles of α1 relative to the axis 1452. At the edge of the beam, dashed line 1462 is parallel to the axis 1452. Ray 1464, representing the propagation direction of the brightest ray at the edge of the beam, propagates in a direction parallel to the axis 1452, in other words the value of θ is zero. Rays 1466, 1468 propagate at an angle of α2 relative to the axis. While the value of θ need not be exactly zero for the beam to be telecentric, the beam is considered to be at least substantially telecentric if the value of θ is no more than 15% of the central cone angle, α1, preferably no more than 10% of α1, more preferably no more than 5% of α1, and even more preferably no more than 1% of α1.

The ultimate brightness of the light incident at the imager device is dependent on the étendue of the illumination light: for a given light source output power, if the étendue of the illumination light is increased, then the resulting projected image is less bright, in other words there is less optical power incident per unit area. Thus, it is important to conserve optical flux density. It is preferred that the optical elements that lead the light from the LEDs to the imaging device do not substantially increase or degrade the étendue of the light beam. The exemplary embodiments of illumination source described below substantially maintain étendue and, therefore, lead to projected images having relatively high brightness.

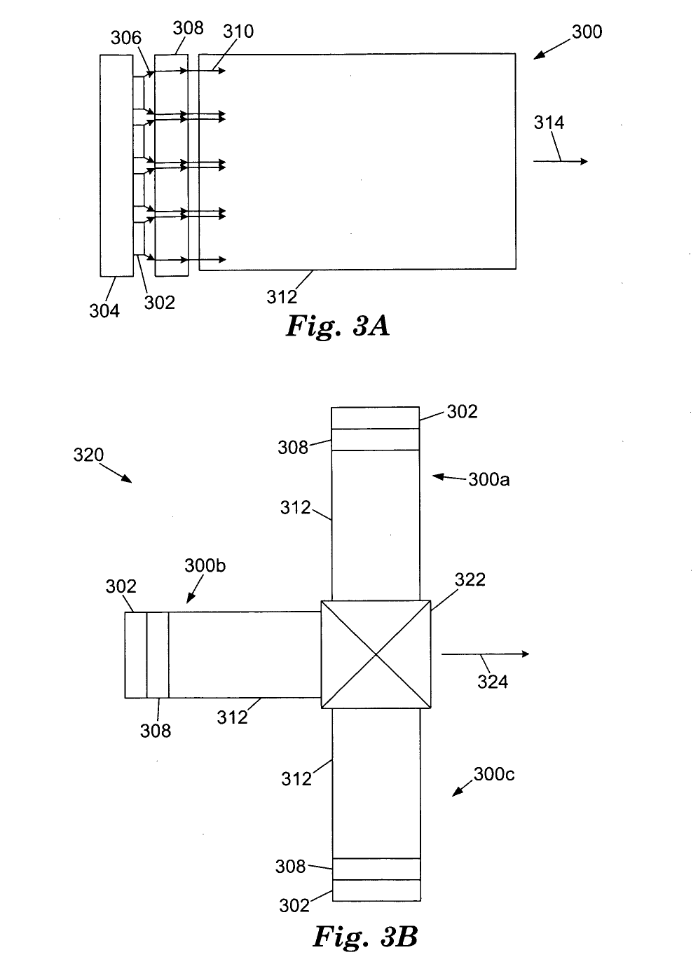

One exemplary illumination system 300 is illustrated schematically in FIG. 3A. A number of light sources 302 are disposed on a base plate 304. The light sources 302 may be devices that emit light in the manner of a point source, a Lambertian source or a quasi-Lambertian source. Examples of such light sources suitable for use in the illumination system include, but are not restricted to, light emitting diodes (LEDs), which are commonly formed of semiconducting materials, and organic light emitting diodes (OLEDs). Typical LEDs are considered to be quasi-Lambertian. The base plate 304 usually provides both electrical power and thermal cooling to the light sources 302. Light 306 from the light sources 302 is transformed by the light-collecting optics 308 into a substantially telecentric light beam. The substantially telecentric light 310 is passed into the tunnel integrator 312, where it undergoes multiple reflections and emerges as an output beam 314. The brightness cross-sectional profile of the output beam 314 is more uniform than that of the light 310 entering the integrator 314 because of the multiple reflections experienced by the light as it propagates along the integrator 314. Accordingly, the output beam is said to be “integrated”.

In some embodiments, the tunnel integrator 312 may be a solid integrator, in which case the light is totally internally reflected at the walls. In other embodiments, the tunnel integrator 312 may be a hollow tunnel, formed by an arrangement of reflecting surfaces: the light externally reflects from the reflecting surfaces as it propagates along the tunnel and is thereby integrated. The tunnel integrator 312 may have any suitable cross-section: in some exemplary embodiments the tunnel is rectangular and in other embodiments the cross-section is square or round. The length of the tunnel integrator is preferably selected to be as short as possible while producing an output beam having the desired level of brightness uniformity. The cross-section of the tunnel need not be constant along its length, and may be tapered. In some embodiments of projection systems, the output end of the tunnel integrator is imaged to the imaging device or devices. Therefore, it is often preferred that the output end of the tunnel integrator have an aspect ratio that is the same as, or close to, the aspect ratio of the imaging device or devices, so as to increase the fraction of light used for generating an image.

The illumination system 300 may contain light sources of one color, or may contain light sources that emit light within a selected range of color. For example, the illumination system 300 may generate light that spans a range of blue wavelengths. In other exemplary embodiments, the light sources 302 may include LEDs provided with phosphors for wavelength converting blue or UV light to broadband, or white, light.

Light from a number of illumination systems 300 may be combined, for example where different illumination systems generate light of different colors. One exemplary embodiment of such an illumination system 320 is schematically illustrated in FIG. 3B. In this particular embodiment, the system 320 contains three illumination sub-systems 300a, 300b, 300c, each producing light in different color ranges, for example red, green and blue respectively. Light from the three sub-systems 300a, 300b and 300c is combined in a color combiner unit 322, illustrated in this embodiment as an x-cube to produce a multiple colored output beam 324. Each illumination sub-combiner, system 300a, 300b, 300c may be formed like the illumination system 300 shown in FIG. 3A.

Different approaches to producing a telecentric light beam from a number of LEDs may be followed. For example, the light-collecting optics may be purely refractive, may be purely reflective or may include both reflective and refractive elements. These different approaches are now discussed in greater detail.

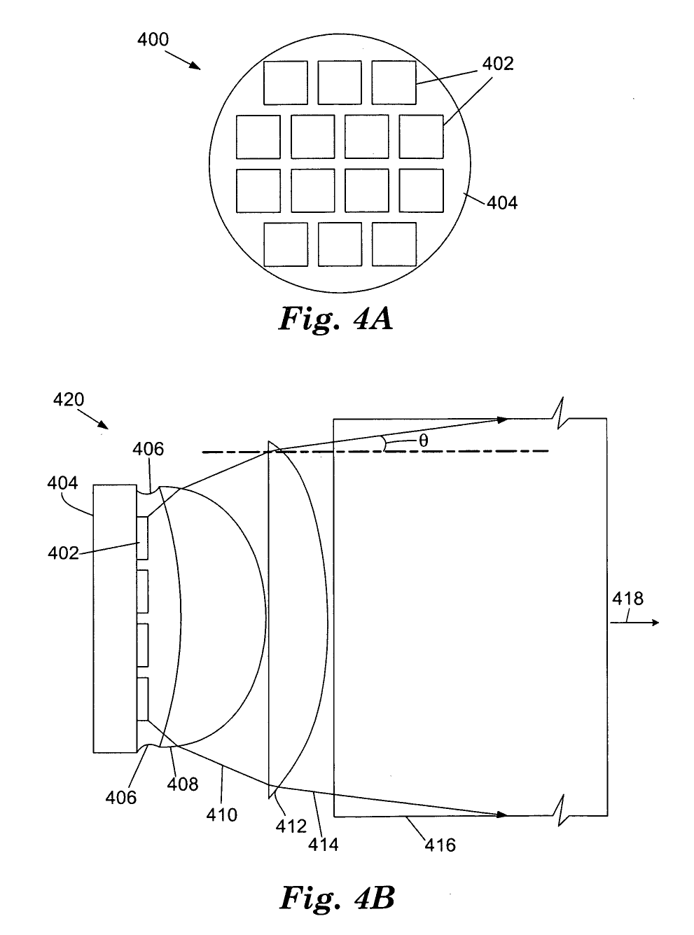

One approach to providing an illumination system using refractive light-collecting optics is now described with respect to FIGS. 4A-4B. FIG. 4A schematically illustrates a partial view of a sub-array device 400. A number of light sources 402, such as LEDs are mounted on a sub-mount 404, to form the sub-array 400. The sub-mount 404 may be planar and may be, for example, a substrate or a circuit board. The light sources 402 may be in the form of LED dies. In the illustrated embodiment, the sub-mount 404 has a circular shape and the light sources 402 are arranged so as to fill the available space on the sub-mount 404 as efficiently as possible or practicable. There are fourteen light source 402 mounted to the surface in the illustrated embodiment. The number of light sources 402 may be different, however, depending on such factors as the size of the light sources 402, the area of the sub-mount 404 and the space between mounted light sources 402. The light sources 402 may be wired in parallel, which enables a “soft” failure mode where, even though one or more of the original light sources has failed, the remaining light sources continue to produce light. The light sources 402 may be wire-bonded to a circuit on the sub-mount 404.

The light sources 402 may be mounted closely together on the sub-mount, but practical issues of heat extraction may limit the number of light sources 402 and/or the closeness of the packing between light sources. For example, where the light sources 402 are square LED dies having a dimension of about 290 μm, and with minimal spacing between adjacent dies, the exemplary arrangement in FIG. 4A may have a diameter of around 1.5 mm. The minimum size of a sub-array may become thermally limited, in which case the space between adjacent LED dies, or other types of light sources may be governed by the ability to extract heat generated by LEDs via the sub-mount 404.

A schematic cross-section view through an illumination system 420 that incorporates the sub-array device 400 is presented in FIG. 4B. An encapsulant 406, for example an encapsulating gel, may be disposed over the light sources 402. Examples of suitable encapsulants include cross-linkable, synthetic polymer fluids such as materials sold under product numbers LS-3252 and LS 3357 by Lightspan LLC, Wareham, Mass.

In this particular embodiment, the light-collecting optics include only refractive elements, namely first and second lenses. The first lens 408 is positioned over the light sources 402 to reduce the divergence of the light 410 emitted by the light sources 402. Reflective losses arising at the interface between the encapsulant 406 and the first lens 408 may be reduced by avoiding air gaps. The first lens 408 may be adhered by the encapsulant 406. The first lens 408 may be spherical or aspherical, and may be a molded lens. The second lens 412 further reduces the divergence of the light 410 from the light sources 402 to produce substantially telecentric light 414 that enters the tunnel integrator 416. The half angle of divergence, θ, of the telecentric light 414 may be, in some embodiments, around 20° or less. The light exits the tunnel integrator 416 as a uniformly bright output beam 418, suitable for illuminating the image display device of a projection system.

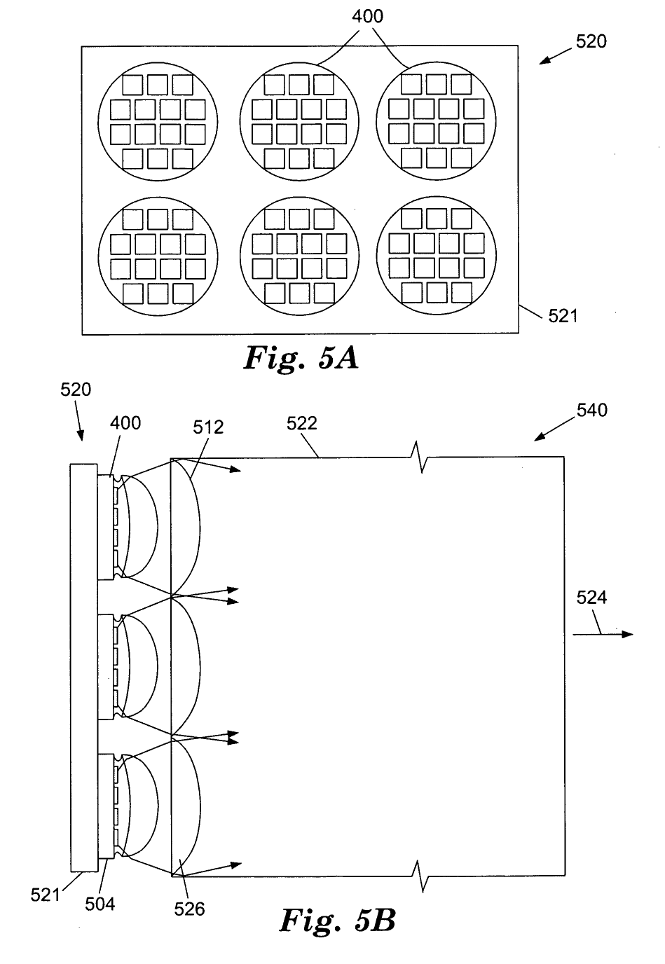

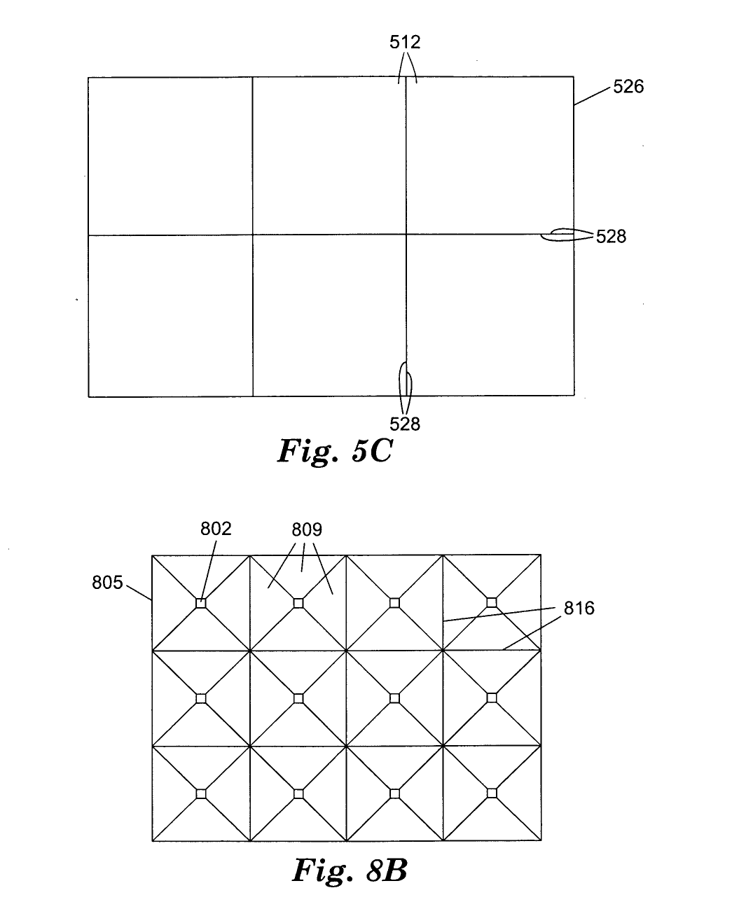

In addition to a single sub-array device 400 feeding light into a tunnel integrator, a number of sub-arrays 400 may be mounted on a back-plane 521 as part of an array 520. In the exemplary embodiment schematically illustrated in FIG. 5A, the array 520 includes six sub-arrays 400. If each sub-array 400 is capable of emitting more than 4 W average power, then the array 520 is capable of emitting more than 24 W. The array 520 may have the light sources arranged in a pattern having an aspect ratio that approximates an aspect ratio that is desirable for illuminating an imager panel. For example, a common aspect ratio for imager panels used in high definition televisions is 16:9, and so the array 520 may have the light sources arranged with the sub arrays 400 in a pattern having an aspect ratio close to this value.

A cross-section through an illumination system 540 that incorporates the array 520 is schematically illustrated in FIG. 5B, which also shows the light from the array 520 optically coupled to a tunnel integrator 522. Light from the array 520 passes through the second lenses 512 into the integrator 522 and the output light 524 from the integrator is relatively uniform in intensity. The second lenses 512 may be provided as separate lenses for each basic array 400 or may be provided as separate lens elements of a molded lens sheet 526 that register to the sub-arrays 400. The second lenses 512 may be any suitable type of lens, such as spherical or aspherical lenses, or the second lenses 512 may be Fresnel lenses.

The sub-mount 504 and backplane 521 may be provided with advantageous thermal properties. For example, if the heat generated by the light sources 402 is sufficiently high, it may be advantageous for at least the sub-mount 504 to have a thermally conducting path to the back plane 521 that has low thermal resistance. The sub-mount 504 may be formed, for example, from a metal-cored circuit board, or from a ceramic that has suitable thermal properties. Examples of ceramic materials that may be used include alumina and aluminum nitride.

An exemplary embodiment of a lens sheet 526 is schematically illustrated in a face-on view in FIG. 5C, showing an arrangement of second lenses 512. The lenses 512 may be arranged with their edges 528 parallel with the edges 528 of the adjacent lenses, thus essentially eliminating “dead space” between lenses. Such an arrangement of lenses may be called edge-matching, since the edges 528 of one lens 512 match the edges 528 of its neighbors. Another description of such an arrangement is that it is “space-filling” because essentially the entire space across the sheet 526 is filled with useful lens area. This type of arrangement permits more of the light emitted by the light sources 502 to enter the tunnel integrator 522 than, for example, an arrangement of circular lenses that necessarily results in dead spaces between the circular lenses. In the illustrated exemplary embodiment, the lenses 512 are square in shape, but may take on other shapes. For example, the lenses 512 may be rectangular, quadrilateral, hexagonal, triangular, or some other shape that permits close packing without dead spaces between the lenses 512. It will be appreciated that lenses do not have to be provided in sheet form to be edge-matched, but may be edge-matched as individual lenses.

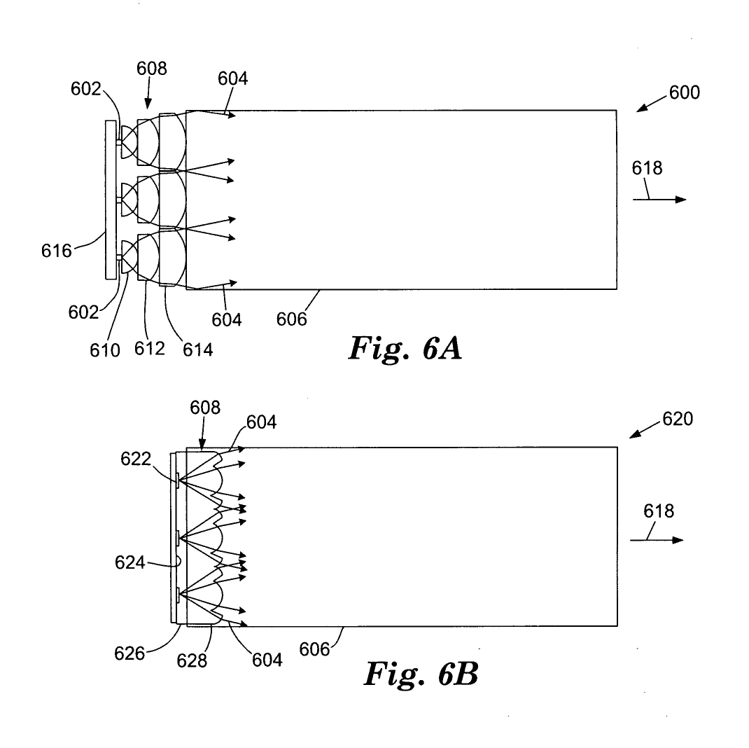

Another type of illumination system 600 is now described with reference to FIGS. 6A and 6B. The illumination system 600 uses an array of light sources 602 to direct light 604 into an integrator 606, for example a tunnel integrator. The light sources may be LEDs, including LED dies. In this exemplary embodiment, light from the light sources 602 is directed through two or more layers of lenses to the integrator 606, and each LED 602 has its own set of lenses. In the illustrated embodiment, the light collecting optics 608 comprise three layers of lenses, 610, 612 and 614. The light sources 602 may be mounted in an array to a board 616. The first layer of lenses 610 may comprise hemispherical lenses. The subsequent layers of lenses 612 and 614 may comprise aspheric or spherical lenses. The lenses may be molded and may be arrayed in sheets. The lenses 614 may be edge-matched. The divergence of the light 604 from the light sources 602 is reduced prior to entry into the integrator 606, and the light is made substantially telecentric. The integrator 606 serves to uniformize the intensity profile of the light 618 output from the source 600.

Another exemplary embodiment of illumination system 620 is schematically illustrated in FIG. 6B, in which light sources 622, for example in the form of LED dies, are mounted in an array on a planar surface 624. Electrical connections to the light sources 622 may be, for example, through the use of wire-bonding. An encapsulant 626 may be provided over the light sources 622 to provide environmental protection and to facilitate the extraction of light from the light sources 622. In this particular embodiment, the light-collecting optics 608 comprises a sheet of arrayed lenses 628 that are registered to the light sources 622. The lenses 628 make the light entering the tunnel 606 substantially telecentric. The lenses 628 may be Fresnel lenses, and may be edge-matched.

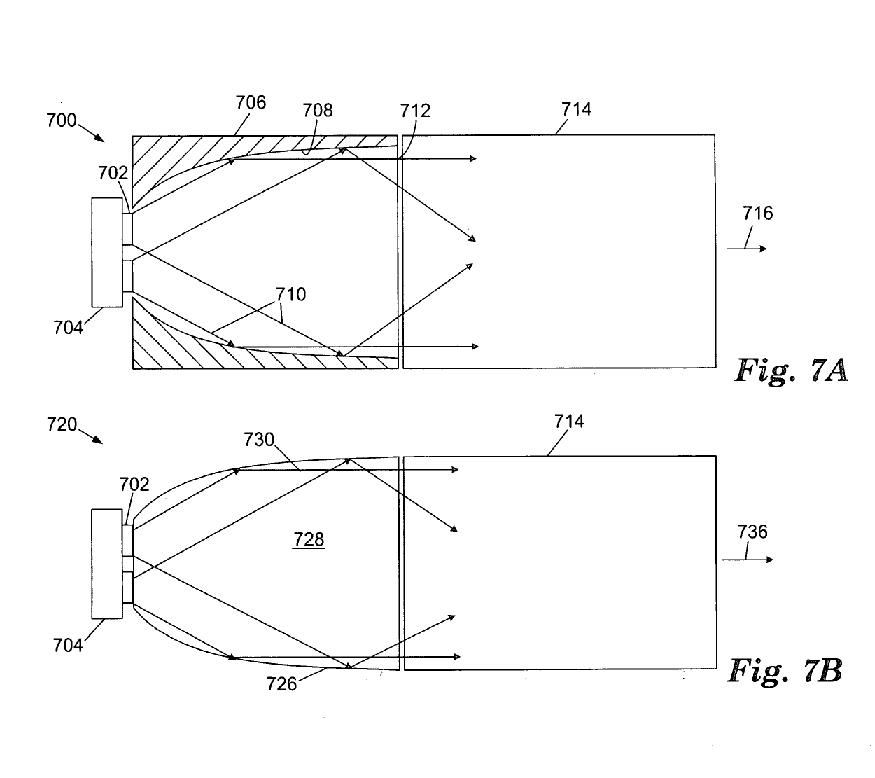

In another approach, the light may be made to be substantially telecentric reflectively, rather than refractively. One exemplary embodiment of this approach is shown for an illumination system 700 schematically illustrated in FIG. 7A. In this exemplary embodiment, a number of light sources 702, for example in the form of LED dies, are mounted to a sub-mount 704. A reflective light-collecting optical element 706, having reflective sidewalls 708, is positioned with its input close to the light sources 702 so that the light 710 from the light sources 702 is focused by reflection from the sidewalls 708. The sidewalls 708 have a curved shape, and may be parabolically curved. The sidewalls 708 may be formed by two intersecting parabolic cylinders, so that the output end 712 of the light-collecting element 706 has a square, rectangular or parallelogram-shaped cross-section. In other embodiments, the sidewalls 708 may form a compound parabolic concentrator (CPC). The light 710 exiting from the light-collecting element 706 is directed into a tunnel integrator 714, with the result that the output light 716 has a uniform intensity cross-section. The reflecting sidewalls 708 may include a mirror coating, such as a metalized coating or a multiple layer dielectric coating, so as to provide high reflectivity.

In the exemplary embodiment of illumination system 720 schematically illustrated in FIG. 7B, the reflective light-collecting optical element 726 is solid and is internally reflecting, so that the light reflects within the material 728 of the element 726. The light 730 may totally internally reflect at the sidewalls of material 728, or the sidewalls of material 728 may be provided with a reflective coating so that the light 730 is substantially telecentric when it enters the tunnel integrator 714. The tunnel integrator 714 then produces an integrated output beam 736.

An encapsulant may be provided over the light sources 702 to increase optical coupling of light out of the light sources 702, and to provide some degree of refractive index matching between the material 728 of the light-collecting element 726 and the LEDs 702.

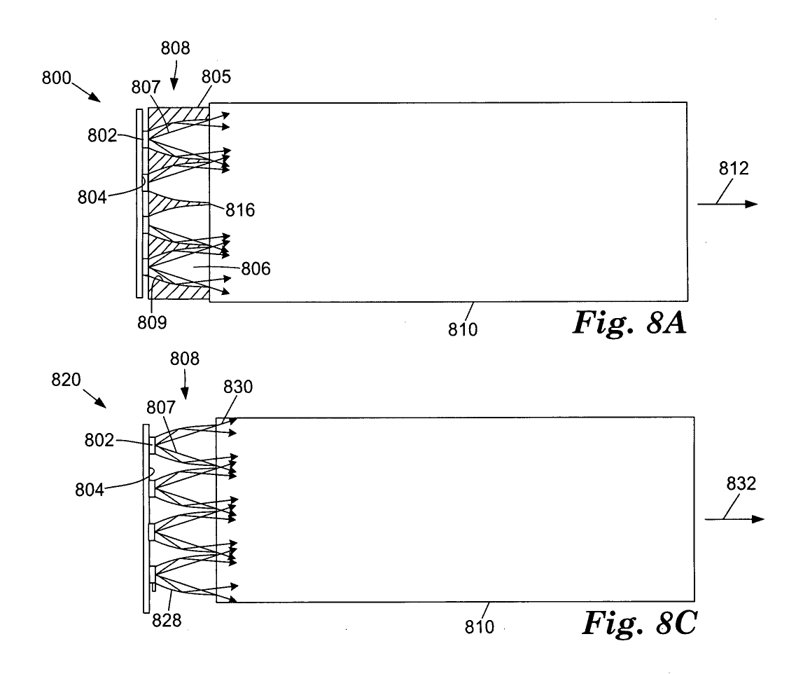

Another embodiment of illumination system 800 is schematically illustrated in FIG. 8A, in which light sources 802, for example in the form of LED dies, are mounted in an array on a sub-mount 804. In this particular embodiment, the light-collecting optics 808 comprises a sheet 805 provided with apertures 806 whose sidewalls are reflectors 809. The apertures 806 are arranged in registration with the light sources 802, so that at least a portion of the light 807 emitted by the light sources 802 passes into the respective apertures 806 and is reflectively coupled by the reflective walls 808 to the integrator 810. The integrator 810 produces an integrated output light beam 812. In this particular embodiment, each light source 802 is associated with its own reflector. An encapsulant may be provided over the light sources 802. The encapsulant may also extend at least part way through the apertures 806.

It will be appreciated that different combinations of reflective and refractive elements may be used to couple the light from the light sources into the tunnel integrator. For example, a lens array may be positioned at the output side of the sheet 804, with lenses registered to the apertures 806, to further reduce the divergence of the light that is transmitted out of the apertures 806.

An exemplary embodiment of a reflector sheet 805 is schematically illustrated in a face-on view in FIG. 8B, showing an arrangement of reflectors 809 associated with individual light sources 802. The reflectors 809 may be arranged with the edges 816 at the output side parallel with the edges 816 of the adjacent reflectors 809, thus essentially eliminating “dead space” between reflectors. Such an arrangement of reflectors may be referred to as edge-matching or space filling. Essentially the entire area of the sheet 805 emits light into the tunnel integrator 810. It will be appreciated that reflectors do not need to be provided in sheet form to be edge matched, and that individual reflectors may be edge-matched.

Another exemplary embodiment of illumination system 820 is schematically illustrated in FIG. 8C, in which light 807 from the light sources 802 is coupled into respective internally reflecting light-collecting optical elements 828. The elements 828 may be totally internally reflecting or may be provided with a reflective coating. The elements 828 are focusing elements, and reduce the divergence of the light so that substantially telecentric light 830 enters the tunnel integrator 810. The elements 828 may be edge-matched. Preferably, the output light 832 has a substantially uniform intensity profile after exiting from the tunnel integrator 810.

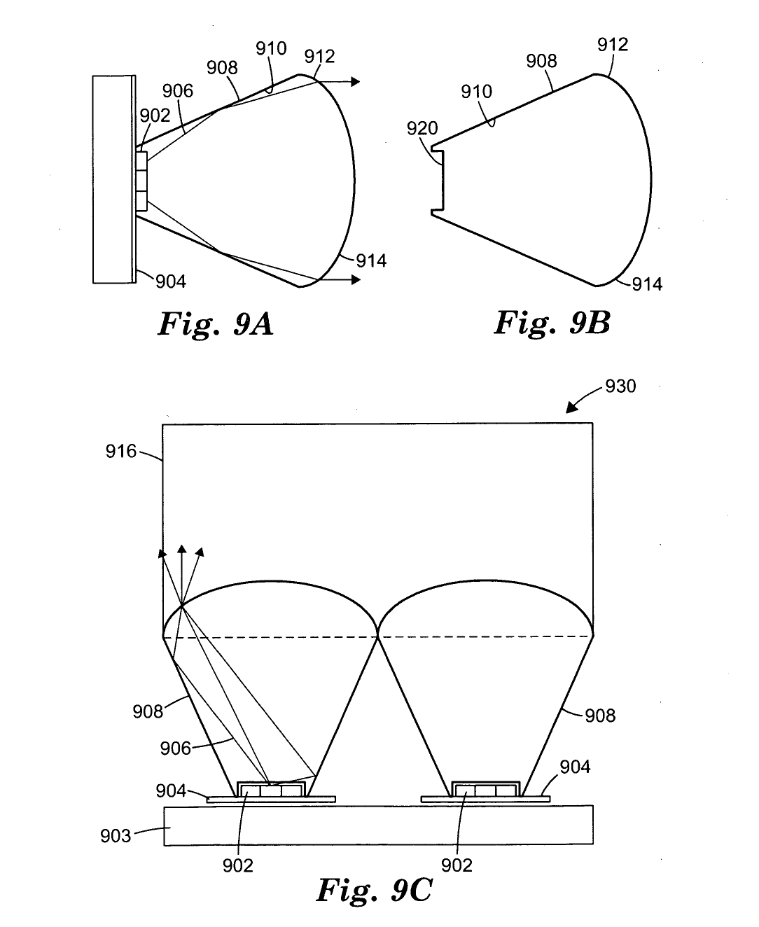

In other approaches, the light from the light sources may be made substantially telecentric using a combination of reflection and refraction. In one approach, schematically illustrated in FIGS. 9A-9C, a light-collecting optical element 908 is used to collect light from a number of light sources 902, such as LEDs, that are mounted on a sub-mount 904. The element 908, illustrated in greater detail in FIG. 9B, is formed of a transparent material and has sidewalls 910 that guide the light 906 from the light sources 902 towards the output end 912. The element 908 may be molded, and may be formed from, for example, glass or a polymer. Some examples of suitable polymer materials include polycarbonate, polymethyl methacrylate, and cyclic olefin copolymer (COC). The output end 912 of the element 908 may be provided with a curved face 914 so that the light passing out of the element 908 towards the tunnel integrator 916 is refracted and becomes substantially telecentric.

The element 908 has an input face 920 that receives the light. The light may be coupled out of the light sources 902 to the input face 920 using a refractive index matching material, for example, silicones and siloxanes. One suitable type of index matching material is material type LS-3252, supplied by Lightspan LLC, Wareham, Mass. An encapsulant over the light sources 902 may serve as a refractive index matching material. The input face 920 may be recessed so that the element 908 captures at least some of the light emitted from the side of the light sources 902.

The light incident on the sidewalls 910 may be totally internally reflected or, may be internally reflected by a reflective coating provided on the sidewalls 910. Furthermore, the reflective coating, if provided, need not extend along the entire length of the element 908. For example, a reflective coating may be provided on the sidewalls 910 close to the input end of the element 908, where there is a greater possibility that light is incident at an angle greater than the critical angle of the material used to make the element. The sidewalls 910 may rely on totally internal reflection closer to the output end 912 of the element, since the possibility of light being incident at an angle greater than the critical angle becomes greater, or the reflective coating may extend to the output end 912.

A number of elements 908 may be used to direct light into a tunnel integrator 916 from a number of respective sub-arrays of light sources 902, for example as is schematically illustrated for the exemplary illumination system 930 shown in FIG. 9C. The different sub-mounts 904 may be mounted to a base plate 903 that provides thermal connectivity to a heatsink. The elements 908 may be edge-matched.

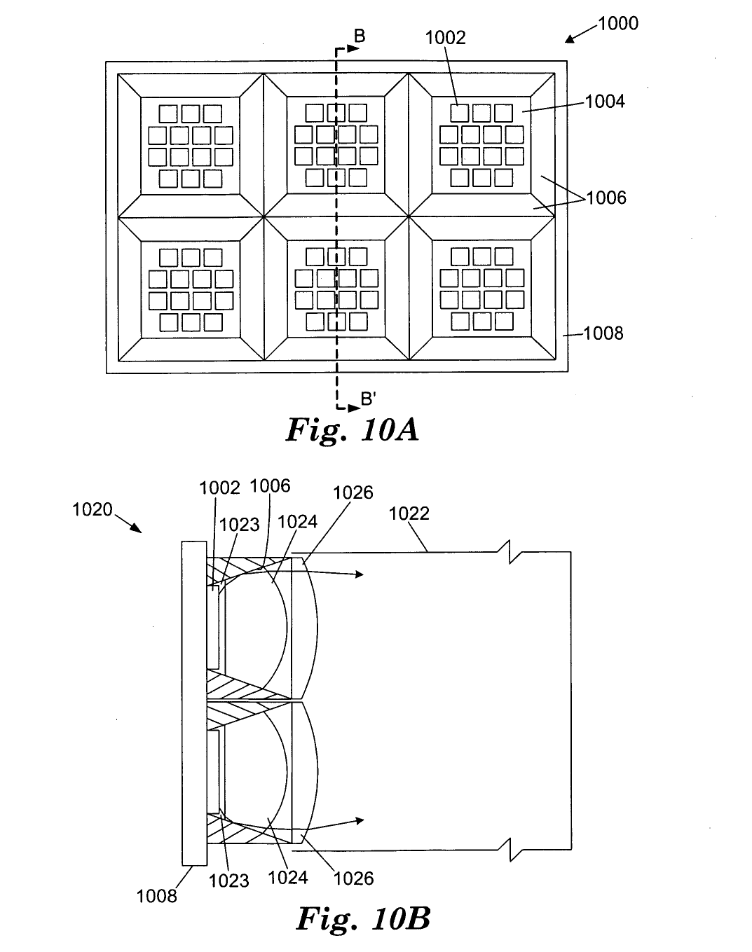

Another exemplary embodiment that uses a combination of reflection and refraction to direct light into a tunnel integrator is now described with reference to FIGS. 10A and 10B. FIG. 10A schematically illustrates an exemplary embodiment of an array 1000 of light sources that comprises a number of sub-arrays 1004. In the illustrated embodiment, there are six sub-arrays 1004. Each sub-array 1004 includes a number of light sources 1002 arranged together. In the exemplary embodiment illustrated in FIG. 10A, each sub-array 1004 contains fourteen LEDs as the light sources 1002, although other types of light sources may be employed. The number of light sources 1002 in the sub-array 1004 may also be smaller or greater than this number. Reflectors 1006 are mounted to the base plate 1008 between the sub-arrays 1004.

In some exemplary embodiments, the reflectors 1006 may be silvered or aluminized mirrors. The reflector 1006 may be formed from a molded piece, or may be formed as a thin metallic surface that is formed into the desired shape. For example, the reflector 1006 may be electroformed.

FIG. 10B schematically illustrates a cross-sectional view BB′ through an illumination system 1020 that uses the array 1000. The reflectors 1006 surrounding each sub-array 1004 are used to reflect light towards the tunnel integrator 1022. In addition, each sub-array 1004 has at least one associated lens for reducing the divergence of the light emitted by the light sources 1002. Two lenses are shown for each sub-array 1004 in this exemplary embodiment. A first lens 1024 is positioned within the space defined by the reflectors 1006, and may be laterally truncated with a pyramidal shape to fit to the reflectors 1006. Consequently, some light may reflect off the reflectors 1006 after entering the first lens 1024. The lenses may be molded, and may be made of glass or polymer. Suitable polymers for molding lenses include polycarbonate (PC), poly methylmethacrylate (PMMA), and cyclic olefin copolymer (COC).

An encapsulant 1023 may be positioned between the light sources 1002 and the first lens 1024. A second lens 1026 may be positioned between the first lens 1024 and the tunnel integrator 1022. The second lenses 1026 may be provided as a sheet of lenses. Either, or both, of the lenses 1024 and 1026 may be aspherical. The second lenses 1026 may be edge-matched.

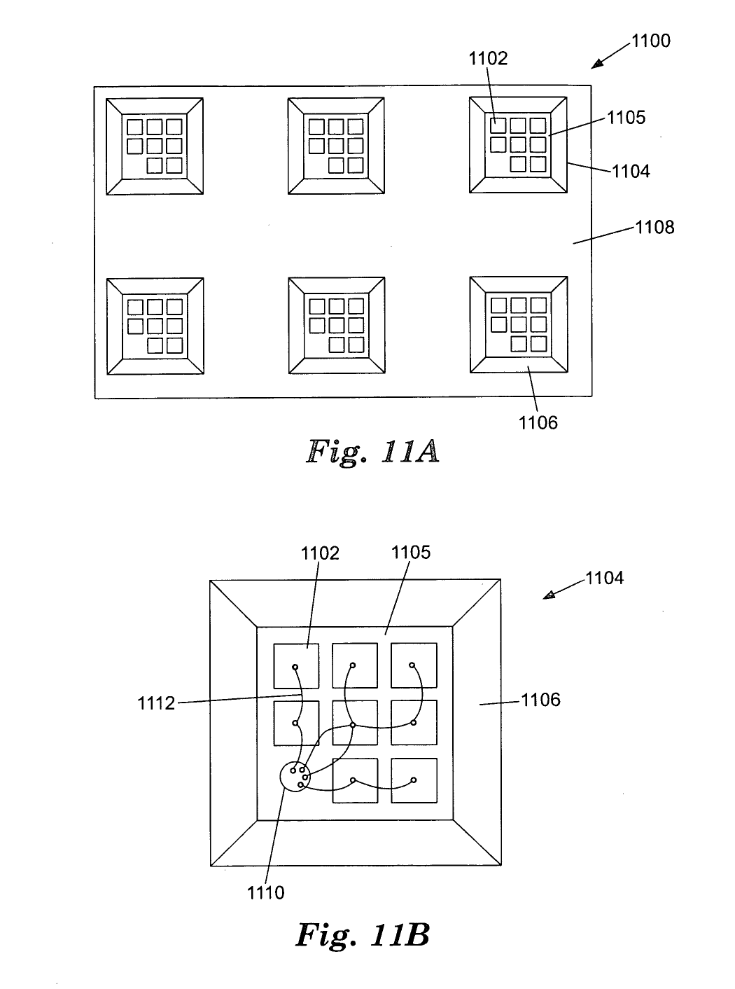

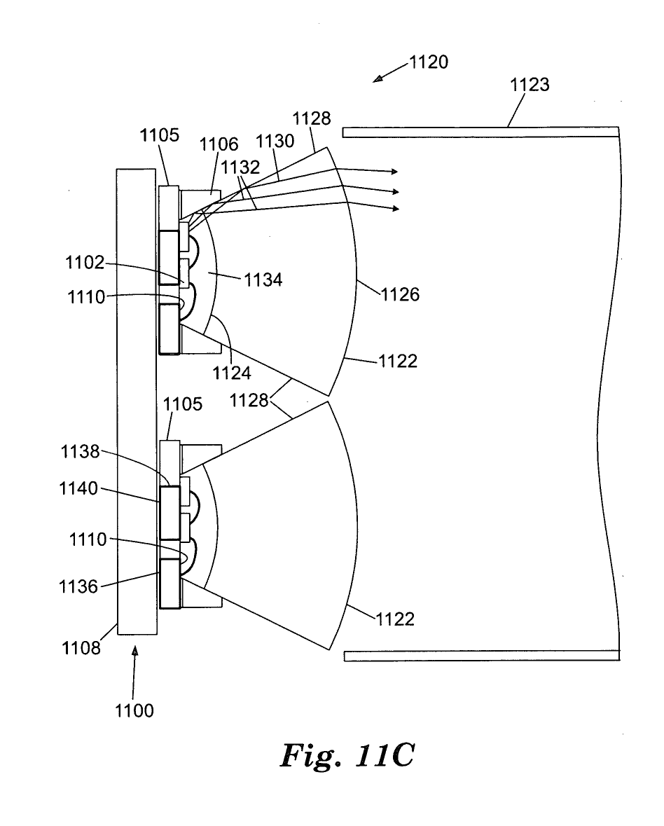

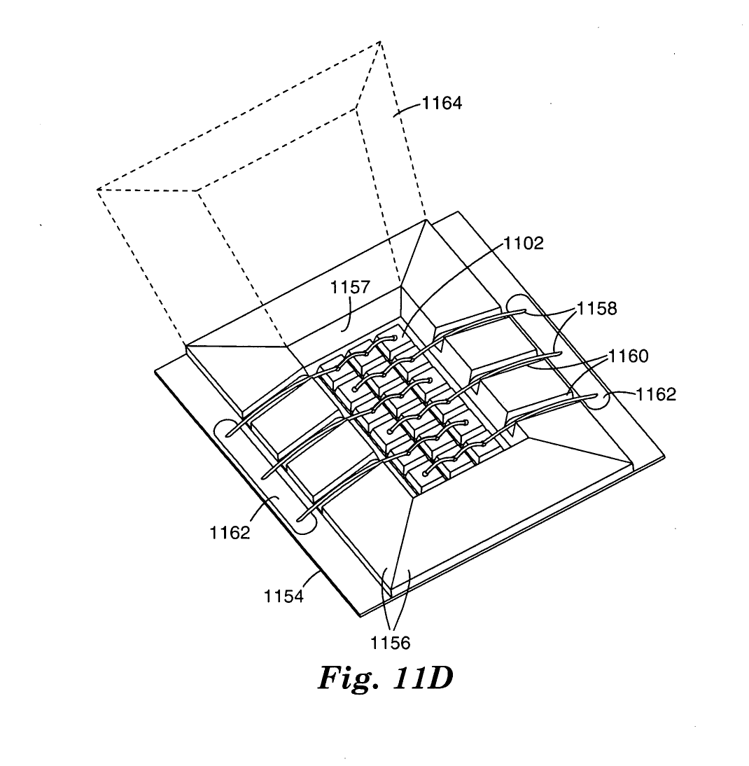

Another approach that uses a combination of reflective and refractive elements for forming substantially telecentric light from a number of light sources is now discussed with reference to FIGS. 11A-11C. FIG. 11A schematically illustrates an exemplary embodiment of an array 1100 of light sources 1102 that comprises a number of sub-arrays 1104, six sub-arrays 1104 in the illustrated embodiment. Each sub-array 1104 includes a number of light sources 1102 arranged together on a sub-mount 1105. The light sources may be, for example, LEDs, such as LED dies. In the exemplary embodiment illustrated in FIG. 11A, each sub-array 1104 contains eight light sources 1102. The number of light sources 1102 in the sub-array 1104 may also be smaller or greater than this number. The sub-arrays 1104 are surrounded by reflectors 1106 that are mounted to the base plate 1108.

In some exemplary embodiments, the reflectors 1106 may be silvered or aluminized mirrors. The reflector 1106 may be formed from a molded piece, or may be formed as a thin metallic surface that is formed into the desired shape. For example, the reflector 1006 may be electroformed.

An expanded view of an exemplary embodiment of one of the sub-arrays 1.104 is provided in FIG. 11B. In this embodiment, the light sources 1102 are arranged in a 3 ×3 square grid pattern, with one of the grid points used by a bonding pad 1110 that is connected to the light sources 1102 via wire bonds 1112. The wire bonds 1112 may be arranged so that the light sources 1102 are operated electrically in parallel. In some exemplary embodiments, there may be a single wire bond 1112 between the bonding pad 1110 and a light source 1102 or between light sources 1102. In other exemplary embodiments, there may be multiple wire bonds 1112 between the bonding pad 1110 and a light source 1102 or between light sources 1102. The use of multiple wire bonds 1112 may, for example, permit carrying higher current or provide redundant current paths. The light sources 1102 may be arranged in different patterns, for example different points of the grid pattern may be lacking light sources or the grid pattern may be different, for example the grid pattern may be hexagonal.

FIG. 11C schematically illustrates a cross-section through an exemplary embodiment of an illumination system 1120 that uses the array 1100. The cross-section is taken through the bonding pads 1110 on two of the sub-arrays 1104. Each sub-array 1104 has an associated lens 1122 that is added after the light sources 1102 are attached to the sub-mount 1105 and wire bonded. The lens 1122 is formed of any suitable transparent material, and may be molded from glass or polymer. Suitable polymers for molding include PC, PMMA and COC. The lens 1122 has first and second surfaces 1124 and 1126, both of which may be curved. The surfaces 1124 and 1126 may each be either spherical or aspherical. The sidewalls 1128 of a lens 1122 fit in between the reflectors 1106 of a sub-array and provide an internally reflecting surface for some of the light 1130 from the light source 1102. Other portions of the light 1132 from the light source 1102 may reflect off the reflector 1106. Light passes out of the lenses 1122 into the tunnel integrator 1123. The lenses 1122 may be edge-matched.

The space between the light sources 1102 and the first lens surface 1124 may be filled with an encapsulant 1134. The encapsulant 1134 may be used to provide environmental protection to the light sources 1102 and to provide index matching with the light sources 1102 for increasing the amount of light extracted from the light sources 1102.

FIG. 11C also shows an exemplary approach to providing electrical current to LEDs when used as the light sources 1102. Similar techniques may be used for other types of light sources 1102. The bond pad 1110 is wire bonded to the top of the LEDs 1102, and is connected to a first contact 1136 on the lower side of the sub-mount 1105. The undersides of the LEDs 1102 are soldered, for example using a reflow process, to vias 1138 that pass through the sub-mount 1105 to a second contact 1140 on the lower surface of the sub-mount 1105. The two contacts 1136 and 1140 may connect to conductors provided on the base plate 1108.

The illustrated embodiment of array 1100 is formed of sub-arrays 1104 that have eight light sources 1102, such as LEDs. The sub-arrays may include different numbers of LEDs 1102 based on considerations of, for example, how much light is to be produced and how much heat can be extracted from the light sources 1102. The heat extraction is limited by the cooling that is provided to the light sources 1102. Increased levels of cooling can permit light sources 1102 to be arranged more closely, with a resulting increase in the brightness of the output beam from the light source. The light sources 1102 may be cooled in different ways. For example, the light sources 1102 may be cooled conductively. In one exemplary embodiment, the heat is conducted away from the light sources 1102 through the sub-mount 1105 and vias 1138 to the base plate 1108 and on to a heatsink. A suitable heatsink may be, for example, a set of fins that passes heat convectively to the air. Accordingly, it is preferred that the sub-mount and base plate be formed of materials with a higher thermal conductivity, thus permitting a higher heat load generated by the light sources. The sub-mount may be formed of, for example, a relatively high thermal conductivity ceramic material such as aluminum oxide (alumina), aluminum nitride or boron nitride. The sub-mount may also be made of a metal with an insulating coating, for example anodized aluminum. In these examples, the material is electrically insulating, and metallic conductors, for example copper traces, may be provided at the appropriate places for carrying electrical current to and from the light sources.

In other embodiments, the sub-mount or base plate may be formed using a metal, such as copper, with some portions provided with appropriate electrical insulation for carrying current to and from the light sources.

A perspective view of a related exemplary embodiment of a sub-array 1150 that may be used in an illumination system is schematically illustrated in FIG. 11D. The sub-array includes a number of light sources 1102, shown as LED dies, distributed on a sub-mount 1154. A first reflector layer 1156 surrounds the light sources 1102. The interior surfaces 1157 of the first reflector layer 1156 may themselves be reflecting. Wire bonds 1158 pass through slots 1160 in the first reflector layer 1156 from bond pads 1162 to the light sources 1102. Thus, the electrical current path passes over the first reflector layer 1156, rather than between the reflector 1106 and the sub-mount 1104, as in the embodiment illustrated in FIG. 11C.

A second reflector layer 1164 may be attached to the first reflector layer 1156, over the slots 1160 of the first reflector layer 1156. The illustration shows only shows part of the second reflector layer 1164, in dashed lines, along only one side of the sub-array 1150. The second reflector layer 1164 may be provided to surround the array of light sources 1102, with a volume defined within the first and second reflector layers 1156, 1164, and above the light sources 1102, to receive a lens (not shown).

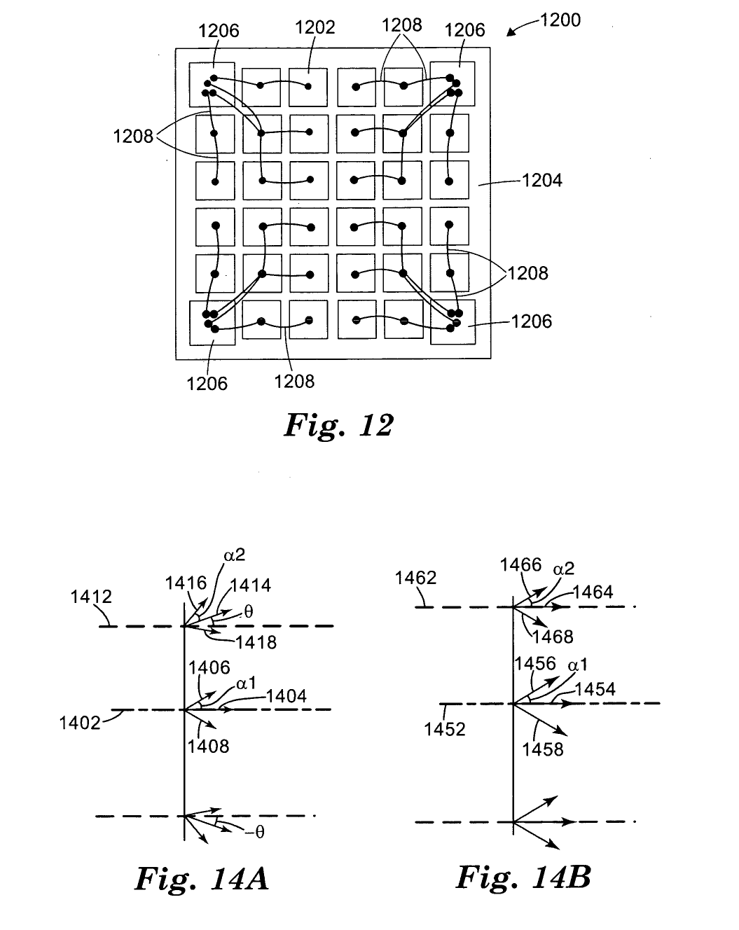

An exemplary embodiment of another sub-array 1200 that includes a different number of light sources 1202 is schematically illustrated in FIG. 12. In this sub-array 1202, the light sources 1202 are mounted on sub-mount 1204 in a 6×6 square grid pattern, with the corner grid positions used for bond pads 1206 for wire bonding to the light sources. Wire bonds 1208 lead from the bond pads 1206 to each light source 1202. Accordingly, the light sources 1202 may be wired in parallel, which permits for “soft failure” of the sub-array 1200. If the sub-array 1200 produces sufficient light, only one sub-array 1200 may be required in a light source.

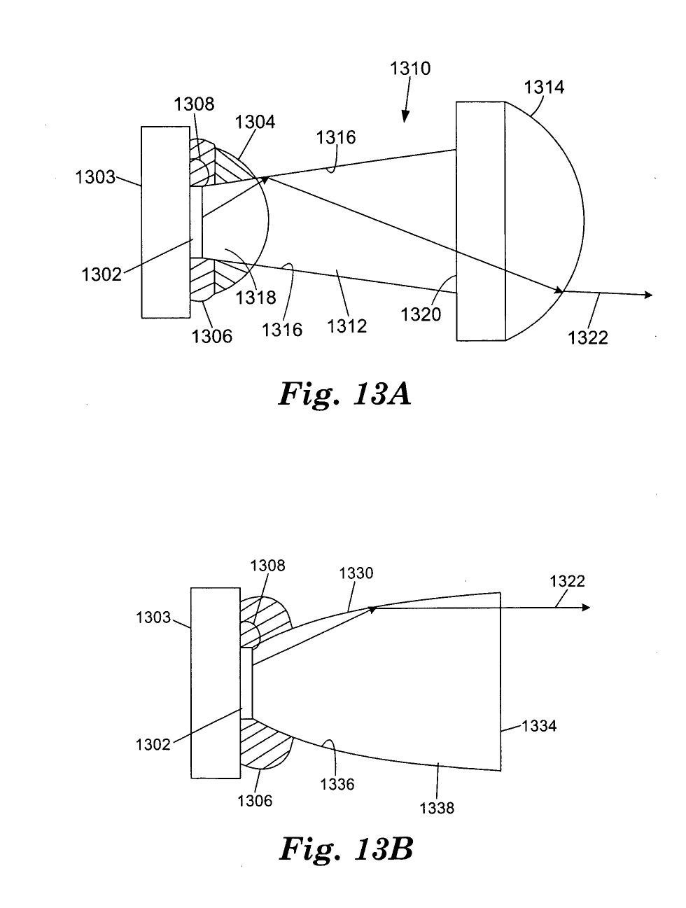

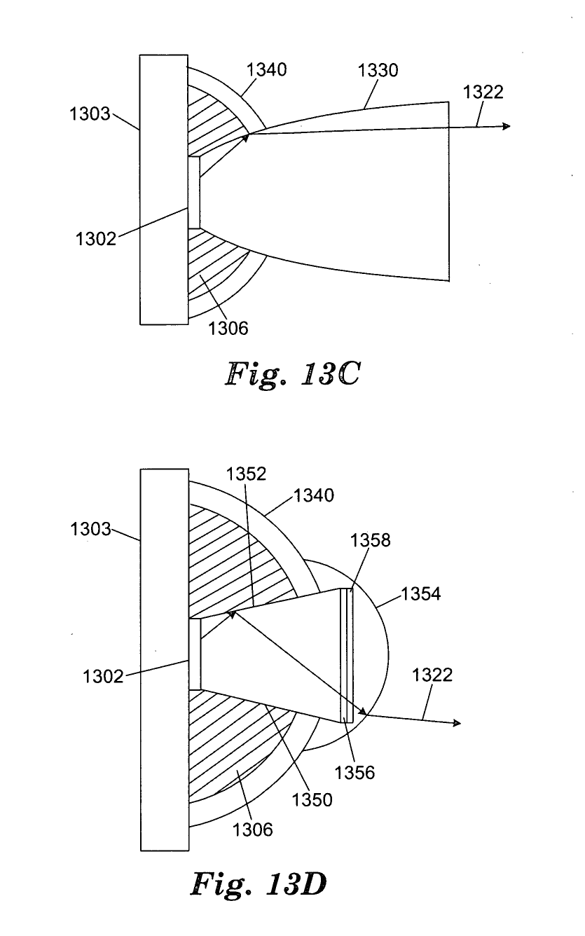

Some LEDs are supplied by the manufacturer with a half-dome lens over the LED die, and an encapsulating gel between the half-dome lens and the LED die. An example of such a device is, for example a Luxeon packaged LED die, supplied by Lumileds Inc. San Jose, Calif. Some approaches to coupling light collecting optics to such LEDs are now discussed with reference to FIGS. 13A-13D. These approaches may also be used for different types of light sources other than LEDs.

FIG. 13A schematically illustrates an LED 1302 mounted on a sub-mount 1303. In some embodiments there is a half-dome lens 1304 over the emitting surface of the LED 1302 with an encapsulant 1306, for example an encapsulating gel, between the LED 1302 and the lens 1304. Such an exemplary structure contains no epoxy resin that may change color with age, thus reducing the light output, nor does it contain silvered reflectors that may change color. The encapsulant covers the wire bonds 1308 to the LED 1302.

A light collection optic 1310 is coupled to receive light at the light-emitting surface of the LED 1302. In this exemplary embodiment, the light collecting optic 1310 comprises a tapered region 1312 and a lens 1314. The tapered region 1312 may be passed through an aperture in the lens 1304, or the lens 1304 may be removed altogether. The tapered region 1312 is passed through the encapsulant 1306 to the light-emitting surface of the LED 1302. The tapered region 1312 is provided with reflecting sidewalls 1316 that include a reflective coating. The sidewalls 1316 may be provided with a metallic coating, for example silver or aluminum, a multiple layer dielectric coating, or a multilayer polymer film coating, to ensure that a large fraction of the light is reflected along the tapered region 1312 optic from its input end 1318 to its output end 1320. The use of a reflective coating permits the sidewalls 1316 to reflect the light from the LED 1302 even though the input end 1318 may be immersed in the encapsulant 1306. Where the reflective coating is metallic, the close proximity of the metallic coating to the surface of the LED 1302 may permit some of the heat generated in the LED 1302 to be conducted away via the metallic coating, thus assisting in the thermal management of the LED 1302.

After extraction via the tapered region, the light is refracted by the lens 1314, so that the light 1322 exiting from the optic 1310 is made to be substantially telecentric.

The light collecting optic need not have straight sidewalls, and may be provided with curved reflecting sidewalls. For example, as is schematically illustrated for the embodiment shown in FIG. 13B, the light collecting optic 1330 is provided with curved reflecting sidewalls 1336. The sidewalls 1336 may be provide with any desired curve profile, for example, parabolic or elliptical, or a compound parabolic concentrator. In this embodiment, the lens 1304 has been removed.

Since, in the embodiments illustrated in FIGS. 13A and 13B, there is very little, or no, encapsulant between the input end of the light collecting optic and the emitting surface of the LED 1302, the encapsulant 1306 need not be transparent, and may be opaque.

It will be appreciated that the optic 1330 may also be provided with a lens at the output end 1334 of the tapered region 1338, although none is shown here. If the encapsulant 1306 does not migrate, then the light collecting optic may simply be mounted to the LED 1302. In certain embodiments, however, for example where the encapsulant 1306 is a gel, the encaspulant may tend to migrate. One approach of controlling the migration of the encapsulant 1306 is to provide an encapsulant cover 1340 that also provides access for the light collecting optic to the LED 1302. One exemplary embodiment of such an approach is schematically illustrated in FIG. 13C, in which a cover 1340 is placed over the encapsulant 1306. The encapsulant 1306 need not be solid if held by the cover, and may be able to flow. The cover 1340 may be integrated with the optic 1330, and need not be transparent.

In another exemplary embodiment, schematically illustrated in FIG. 13D, the light collecting optic 1350 may have a tapered region 1352 and a lens 1354, integrated with a cover 1340. Furthermore, in this embodiment, or optionally in one of the other exemplary embodiments discussed above, a phosphor layer 1356 may be placed at the end of the reflecting element for wavelength converting the light emitted by the LED 1302. In addition, one or more layers of multilayer optical film (MOF) may be positioned to one or both sides of the phosphor to increase the wavelength conversion efficiency. The use of MOF with phosphor is discussed further in U.S. patent application Ser. No. 10/727,072, incorporated herein by reference.

The different exemplary embodiments of light collecting optics described above with reference to FIGS. 13A-13D may be used in array form, with arrays of light sources, and may be edge-matched.

The present disclosure should not be considered limited to the particular examples described above, but rather should be understood to cover all aspects as fairly set out in the attached claims. Various modifications, equivalent processes, as well as numerous structures to which the present disclosure may be applicable will be readily apparent to those of skill in the art to which the present disclosure is directed upon review of the present specification. The claims are intended to cover such modifications and devices.

What is claimed is:

1. An optical system, comprising:
a plurality of light sources capable of emitting output light;
an integrating tunnel having an input end; and
a light-collecting optical system disposed between the plurality of light sources and the input end of the integrating tunnel, the light-collecting system transforming at least a portion of the output light from the plurality of light sources into a substantially telecentric illumination beam, the substantially telecentric illumination beam being coupled to the integrating tunnel.

2. A system as recited in claim 1, wherein the light sources of the plurality of light sources are mounted in at least two sub-arrays, the sub-arrays being associated with respective focusing elements, the focusing elements making the light from respective the light sources substantially telecentric.

3. A system as recited in claim 1, wherein the light-collecting optical system comprises edge-matched reflective or refractive optical elements.

4. A system as recited in claim 1, wherein the light-collecting optical system comprises at least one refractive or reflective focusing element that focuses light from more than one light source.

5. A system as recited in claim 4, wherein the light-collecting optical system comprises at least one set of lenses, the at least one set of lenses comprising at least a first lens that reduces divergence of light from at least two light sources and at least a second lens that reduces divergence of light received from the at least the first lens.

6. A system as recited in claim 5, wherein the light-collecting optical system further comprises at least two sets of lenses, each set of lenses being associated with at least one respective light source.

7. A system as recited in claim 5, wherein the light-collecting optical system further comprises at least one reflective element and at least one refractive element.

8. A system as recited in claim 7, wherein the at least one reflective element comprises straight, reflective sidewalls, at least some of the light from the light sources being directed to the at least one refractive element via reflection at the sidewalls.

9. A system as recited in claim 7, wherein the light sources are arranged in one or more sub-arrays and the light-collecting system further comprises a reflector unit and a set of one or more lenses for each sub-array.

10. A system as recited in claim 9, wherein the reflector unit comprises non-parallel, opposing reflective sidewalls, at least a first lens of the one or more lenses being disposed between the opposing sidewalls.

11. A system as recited in claim 10, further comprising an encapsulant disposed between the light sources of a sub-array and its associated first lens.

12. A system as recited in claim 1, wherein the light sources are mounted to a sub-mount and the light-collecting optical system comprises a reflector attached to the sub-mount and surrounding the light sources, and at least a first lens, the reflector and at least a first lens directing substantially telecentric light from the light sources to the tunnel integrator.

13. A system as recited in claim 12, wherein the reflector extends outwardly from the sub-mount generally in a direction of the light emitted by the light sources to define a volume above the light sources, at least the first lens being positioned within the volume defined by the reflector.

14. A system as recited in claim 12, wherein the reflector comprises a single reflector layer and electrical connections are made from outside the reflector to the light sources via at least one conductor that passes between the reflector and the sub-mount.

15. A system as recited in claim 12, wherein the reflector comprises at least two reflector layers and electrical connections are made from outside the reflector to the light sources via at least one conductor that passes between the two reflector layers.

16. A system as recited in claim 15, wherein the at least one reflective element totally internally reflects at least some of the light from at least one of the light sources or reflects light from at least one of the light sources via a reflective coating.

17. A system as recited in claim 1, wherein the light-collecting optical system comprises at least one reflector unit.

18. A system as recited in claim 17, wherein the at least one reflector unit has sidewalls defining a parabolic cross-section.

19. A system as recited in claim 17, wherein the light sources are arranged in at least two sub-arrays and the light-collecting system further comprises at least two reflector units, each reflector unit being associated with a respective sub-array.

20. A system as recited in claim 1, wherein the light sources are arranged in a regular grid pattern, a bonding pad being disposed at at least one grid point of the regular grid pattern for providing electrical connections to the light sources.

21. An illumination unit for a projection system, comprising:
a plurality of light sources capable of producing light;
light telecentrizing means for making at least some of the light from the light sources substantially telecentric; and
light tunnel integrating means for making the substantially telecentric light into an illumination beam of uniform brightness.

22. A projection system, comprising:
an illumination system comprising a first illumination sub-system comprising
a plurality of light sources capable of emitting output light,
an integrating tunnel having an input end, and
a light-collecting optical system disposed between the plurality of light sources and the integrating tunnel, the light-collecting optical system transforming at least some of the output light from the plurality of light sources into a substantially telecentric illumination beam, the substantially telecentric illumination beam being integrated by the integrating tunnel to produce an integrated illumination beam; and
at least a first image forming device illuminated by the integrated illumination beam.

23. A system as recited in claim 22, further comprising a control unit coupled to the at least a first image-forming device to control an image formed by the at least a first image-forming device.

24. A system as recited in claim 22, wherein the first illumination sub-system generates light in a first color range and the illumination system comprises at least a second illumination sub-system generating light in a second color range different from the first color range.

25. A system as recited in claim 24, wherein the illumination system further comprises a color combiner that combines light beams from the first and second illumination sub-systems to form a combined illumination beam, the combined illumination beam being directed to the at least a first image-forming device.

26. A system as recited in claim 24, further comprising at least a second image-forming device, the first image-forming device being illuminated by light from the first illumination sub-system and the second image-forming device being illuminated by light from the second illumination sub-system.

27. A system as recited in claim 22, further comprising second and third image-forming devices, the first, second and third image-forming devices being illuminated by first, second and third illumination sub-systems respectively, and further comprising a color combining unit, first, second and third colored image beams from the first, second and third image forming devices being combined in the color combining unit to produce a full colored image beam.

28. An optical system, comprising:
a first light source;
a first reflective tunnel having an output end;
a second reflective tunnel having an input end optically coupled to the output end of the first reflective tunnel, a cross-sectional dimension of the output end of the first reflective tunnel being smaller than a cross-sectional dimension of the input end of the second integrating tunnel;
wherein light from the first light sources passes through the first reflective tunnel to the second reflective tunnel.

29. A system as recited in claim 28, wherein the light entering the second tunnel is telecentric.

30. A system as recited in claim 29, further comprising at least one refractive or reflective element disposed between the first tunnel and the second tunnel.

31. A system as recited in claim 28, further comprising a second light source and a third reflective tunnel having an output end, the output end of the third reflective tunnel being optically coupled to the input end of the second reflective tunnel, a cross-sectional dimension of the output end of the third reflective tunnel and the cross-sectional dimension of the output end of the first reflective tunnel each being less than one half of the cross-sectional dimension of the input end of the second reflective tunnel.
